(19) United States
(12) Patent Application Publication
(10) Pub. No.: US 2026/0279339 A1
(43) Pub. Date: Sep. 17, 2026

(54) DIALOGUE MODEL TRAINING

(71) Applicant: MASHANG CONSUMER FINANCE CO., LTD., Chongqing (CN)

(72) Inventor: Qinglin MENG, Chongqing (CN)

(73) Assignee: MASHANG CONSUMER FINANCE CO., LTD., Chongqing (CN)

(21) Appl. No.: 19/311,766

(22) Filed: Aug. 27, 2025

(30) Foreign Application Priority Data
Mar. 12, 2025 (CN) 202510293054.X

(51) Int. Cl. G10L 15/06; G10L 15/26

(52) U.S. Cl. CPC G10L 15/063; G10L 15/26

(57) ABSTRACT

In a method for training a dialogue model, a first audio sample and a second text sample of a second audio sample are obtained. The second audio sample is before the first audio sample. A first text sample is generated based on speech recognition that is performed on the first audio sample. Through a first dialogue model, a first predicted reply text for the first audio sample is generated based on a first text feature of the first text sample, a first audio feature of the first audio sample, and a second text feature of the second text sample. The first dialogue model is trained based on the first predicted reply text.

### RELATED APPLICATION

The present application claims priority to Chinese Patent Application No. 202510293054.X, filed on Mar. 12, 2025, which is hereby incorporated by reference in its entirety.

### FIELD OF THE TECHNOLOGY

This application relates to the technical field of artificial intelligence, including a method for training a dialogue model.

### BACKGROUND OF THE DISCLOSURE

In recent years, an end-to-end speech recognition system of a large language model (LLM) has made remarkable progress. Applying speech recognition system to automated customer service dialogues has become the prevailing pursuit for major companies. At present, in the automatic customer service dialogue solution, the speech of users is converted into a dialogue text, and then a reply text for the dialogue text is generated with the large model. Then the reply text is converted into a corresponding reply audio, and is returned to the users. In this way, the automatic dialogue with the users is conducted.

In a process of generating the reply text, the speech cannot be understood from the model level, which results in low precision of the generated reply text, and poor experience of the users.

### SUMMARY

Aspects of this disclosure include a method for training a dialogue model, a dialogue method, and a dialogue apparatus, which can improve reply precision of an intelligent customer service dialogue and improve experience of a user. Examples of technical solutions of this disclosure may be implemented as follows:

An aspect of this disclosure provides a method for training a dialogue model. In the method, a first audio sample and a second text sample of a second audio sample are obtained. The second audio sample is before the first audio sample. A first text sample is generated based on speech recognition that is performed on the first audio sample. Through a first dialogue model, a first predicted reply text for the first audio sample is generated based on a first text feature of the first text sample, a first audio feature of the first audio sample, and a second text feature of the second text sample. The first dialogue model is trained based on the first predicted reply text.

An aspect of this disclosure provides a dialogue method. In the method, an audio input and a dialogue text input are obtained. The dialogue text input is obtained before the audio input. Through a trained dialogue model, a predicted reply text for the audio input is generated based on the audio input and the dialogue text input. The predicted reply text is converted into a reply audio. A reply to the audio input is output based on the reply audio. The trained dialogue model is trained with sample predicted reply text for a first audio sample. The sample predicted reply text is generated through a first dialogue model based on a first sample text feature of a first text sample, a first audio feature of the first audio sample, and a second sample text feature of a second text sample. The first text sample is generated based on speech recognition that is performed on the first audio sample. The second text sample is obtained from a second audio sample. The second text sample is obtained before the first audio sample.

An aspect of this disclosure provides a dialogue apparatus. The apparatus includes processing circuitry configured to obtain an audio input, and a dialogue text input that is obtained before the audio input. The processing circuitry is configured to generate, through a trained dialogue model, a predicted reply text for the audio input based on the audio input and the dialogue text input. The processing circuitry is configured to convert the predicted reply text into a reply audio. The processing circuitry is configured to output a reply to the audio input based on the reply audio. The trained dialogue model is trained with sample predicted reply text for a first audio sample. The sample predicted reply text is generated through a first dialogue model based on a first sample text feature of a first text sample, a first audio feature of the first audio sample, and a second sample text feature of a second text sample. The first text sample is generated based on speech recognition that is performed on the first audio sample. The second text sample is obtained from a second audio sample. The second text sample is obtained before the first audio sample.

An aspect of this disclosure provides a method for training a model. The method includes: acquiring a first user audio sample of a first round and a first dialogue text sample of a second round, the first round and the second round belonging to the same dialogue round, and the second round being before the first round; performing text recognition on the first user audio sample, and acquiring a first text sample of the first user audio sample; predicting a first reply text for the first user audio sample based on a first text feature of the first text sample, a first audio feature of the first user audio sample, and a second text feature of the first dialogue text sample; and training a first model based on the first reply text.

An aspect of this disclosure provides a dialogue method. The dialogue method includes: acquiring a user audio of a fifth round and a dialogue text of a sixth round, the fifth round and the sixth round belonging to the same dialogue round, and the sixth round being before the fifth round; inputting a content of the user audio and a content of the dialogue text into the model trained by the method in the first aspect, and acquiring a fourth reply text for the user audio; performing audio conversion on the fourth reply text, and acquiring a reply audio for the user audio; and conducting a dialogue of the fifth round with a user based on the reply audio.

An aspect of this disclosure provides an apparatus for training a model. The apparatus includes: an acquiring unit configured to acquire a first user audio sample of a first round and a first dialogue text sample of a second round, the first round and the second round belonging to the same dialogue round, and the second round being before the first round; and a processing unit configured to perform text recognition on the first user audio sample, and acquire a first text sample of the first user audio sample; predict a first reply text for the first user audio sample based on a first text feature of the first text sample, a first audio feature of the first user audio sample, and a second text feature of the first dialogue text sample; and train a first model based on the first reply text.

An aspect of this disclosure provides a dialogue apparatus. The dialogue apparatus includes: an acquiring unit configured to acquire a user audio of a fifth round and a dialogue text of a sixth round, the fifth round and the sixth round belonging to the same dialogue round, and the sixth round being before the fifth round; and a processing unit configured to input a content of the user audio and a content of the dialogue text into the model trained by the method in the first aspect, and acquire a fourth reply text for the user audio; perform audio conversion on the fourth reply text, and acquire a reply audio for the user audio; and conduct a dialogue of the fifth round with a user based on the reply audio.

An aspect of this disclosure provides an electronic device. The electronic device includes: a processor and a memory, the processor being connected to the memory, the memory being configured to store a computer program, and the processor being configured to execute the computer program stored in the memory, so as to cause the electronic device to perform the method in the first aspect or the second aspect.

An aspect of this disclosure provides a non-transitory computer-readable storage medium, having computer-executable instructions stored therein, the computer-executable instructions, when executed by a processor, cause the processor to implement the method of the dialogue method.

An aspect of this disclosure provides a computer program product. The computer program product includes a computer program, the computer program, when executed by a processor, implements the method in a first aspect or a second aspect.

The technical solutions provided in the aspects of this disclosure can achieve at least the following beneficial effects.

According to the aspects of this disclosure, when the model for the dialogue is trained, the audio sample is converted into a corresponding text sample at first, then the text feature of the text sample in a dimension is acquired, and the text feature of the audio sample in a text dimension is further acquired. In addition, audio feature extraction is performed on the audio sample, and the audio feature of the audio sample in an audio dimension is acquired. Then, the model is trained comprehensively by using the text feature of the audio sample in the text dimension, the audio feature of the audio sample in the audio dimension, and a text feature of a historical dialogue. In this way, during training, the audio feature and the text feature can learn from each other, and a training effect of the model can be improved accordingly. Precision of the reply text outputted by the model is not affected even if precision of the feature in a particular dimension is insufficient. Thus, robustness of the model is improved, the user can be provided with a high-precision reply text, and the experience of the user in the intelligent customer service dialogue can be improved.

### BRIEF DESCRIPTION OF THE DRAWINGS

To describe technical solutions in the aspects of this disclosure, the accompanying drawings are briefly introduced below.

FIG. 1 is a schematic diagram of a dialogue system according to an aspect of this disclosure;

FIG. 2 is a schematic diagram of a dialogue based on a trained model according to an aspect of this disclosure;

FIG. 3 is a schematic diagram of another dialogue based on a trained model according to an aspect of this disclosure;

FIG. 4 is a schematic flowchart of a method for training a model according to an aspect of this disclosure;

FIG. 5 is a schematic flowchart of a dialogue method according to an aspect of this disclosure;

FIG. 6 is a schematic diagram of an apparatus for training a model according to an aspect of this disclosure;

FIG. 7 is a schematic diagram of a dialogue apparatus according to an aspect of this disclosure; and

FIG. 8 is a schematic diagram of an electronic device according to an aspect of this disclosure.

### DETAILED DESCRIPTION

Technical solutions in the aspects of this disclosure are described below in conjunction the accompanying drawings. The aspects described are merely some aspects rather than all aspects of this disclosure. Other aspects are within the scope of this disclosure. The descriptions of the terms are provided as examples only and are not intended to limit the scope of the disclosure.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The terms “first”, “second”, “third”, “fourth”, etc. in the description, and the claims and the accompanying drawings of this disclosure are used to distinguish different objects, rather than describe a specific order. In addition, the terms “comprise”, “include”, “has” and their any form of variation are intended to cover non-exclusive inclusions. For example, a process, a method, a system, a product, or a device that includes a series of steps or units is not limited to listed steps or modules, but may further include a step or a module that is not listed in some aspects, or may further include another step unit inherent to the process, the method, the product, or the device in some aspects.

Reference to the “aspect” herein means that a specific feature, result, or characteristic described in conjunction with the aspect may be included in at least one aspect of this disclosure. The appearance of this phrase in different places throughout the description does not necessarily mean the same aspect, or an independent or alternative aspect mutually exclusive with other aspects. It is noted that the aspects described herein can be combined with another aspect.

First of all, a dialogue method of this disclosure is can be applied to various dialogue scenarios, for example, an intelligent customer service dialogue scenario where an intelligent robot conducts a dialogue with a user and provides the user with a corresponding service, or an intelligent shopping guide scenario where the intelligent robot conducts the dialogue with the user and provides the user with a shopping guide service, for example. For the convenience of description, this disclosure is described with the intelligent user dialogue scenario being the dialogue scenario as an example.

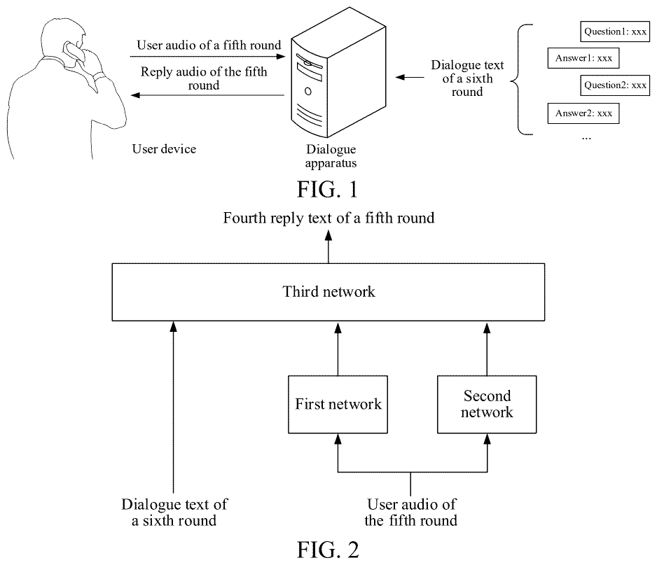

FIG. 1 is a schematic diagram of a dialogue system according to an aspect of this disclosure. The dialogue system includes a user device and a dialogue apparatus. The dialogue system may be a dialogue system in an intelligent customer service scenario.

As shown in FIG. 1, the user device collects a user audio of a fifth round from a user, and then transmits the user audio to the dialogue apparatus. Correspondingly, the dialogue apparatus receives the user audio, and acquires a dialogue text of a sixth round. The fifth round and the sixth round belong to the same dialogue round, and the sixth round is before the fifth round. Then, the dialogue apparatus inputs the user audio and the dialogue text as inputted data into a trained model of this disclosure, and acquires a fourth reply text for the user audio. Further, the dialogue apparatus performs audio conversion on the fourth reply text, and acquires a reply audio for the user audio, that is, the reply audio of the fifth round is acquired. Finally, the dialogue apparatus returns the reply audio to the user device, thus completing a dialogue of the fifth round with the user.

FIG. 2 is a schematic diagram of a dialogue based on a trained model according to an aspect of this disclosure.

As shown in FIG. 2, the model includes a first network, a second network, and a third network. The first network is configured to perform text feature extraction, the second network configured to perform audio feature extraction, and the third network is configured to generate a reply text.

For example, as shown in FIG. 2, a user audio of a fifth round (a current round), that is, an audio provided by a user in a current dialogue round is acquired. The user audio is inputted into a first network and a second network, the text feature extraction is performed on the user audio through the first network to acquire a user text of the user audio. The audio feature extraction is performed on the user audio through the second network to acquire an audio feature of the user audio.

Then, the user text and the audio feature of the user audio, and a dialogue text of a sixth round (a historical round) are inputted into the third network for text generation. The reply text for the user audio is acquired, that is, a fourth reply text of the fifth round is acquired.

Further, audio conversion is performed on the fourth reply text to acquire a reply audio for the user audio, and a dialogue of the fifth round (the current round) is conducted with the user based on the reply audio.

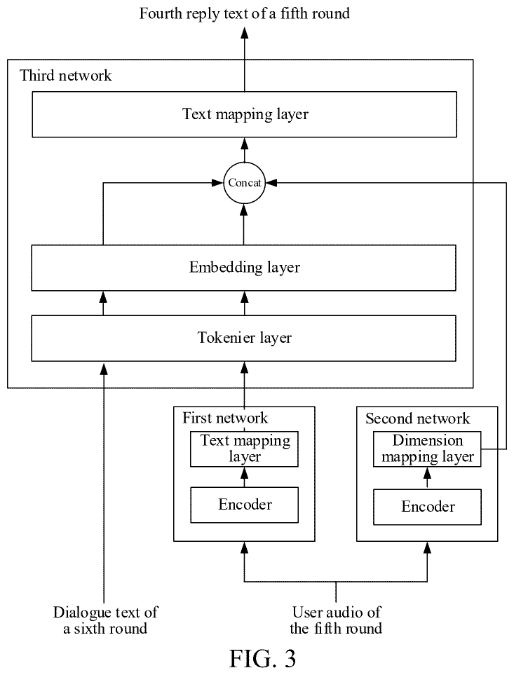

FIG. 3 is a schematic diagram of another dialogue based on a trained model according to an aspect of this disclosure.

As shown in FIG. 3, a first network includes a text mapping layer and an encoder, and a second network includes an encoder and a dimension mapping layer. A third network includes a tokenier layer, an embedding layer, and a text mapping layer.

The first network may be any network having an audio recognition function, for example, a conformer network, and the second network may be any network having an audio feature extraction capacity. This disclosure is mainly described with the second network and the first network being networks of the same type as an example. For example, the encoder of an initial second network is identical to the encoder of the first network. For example, after the first network is trained, the text mapping layer of the first network is deleted to acquire the initial second network. The third network is a large language model (LLM).

For example, a user audio of a fifth round is inputted into the encoder of the first network, and feature extraction is performed on the user audio to acquire a third audio feature. Then, the third audio feature is inputted into the text mapping layer of the first network, and text mapping is performed to acquire a user text corresponding to the user audio. The user audio is inputted into the encoder of the second network, and the feature extraction is performed on the user audio to acquire a fourth audio feature. Then, the fourth audio feature is inputted into the dimension mapping layer to map a fifth audio feature whose dimension satisfies a requirement from the third network. Then, a dialogue text of a sixth round is inputted into the tokenier layer of the third network, tokenization is performed to acquire a plurality of tokens of the dialogue text. The user text is inputted into the tokenier layer of the third network, and tokenization is performed to acquire a plurality of tokens of the user text. Then, the plurality of tokens of the user text are inputted into the embedding layer of the third network, and are embedded, and a text feature of the user text is acquired. The plurality of tokens of the dialogue text are inputted into the embedding layer of the third network, and are embedded, and a text feature of the dialogue text is acquired.

Further, the text feature of the user text, the text feature of the dialogue text, and the fifth audio feature are spliced to acquire a second comprehensive feature. Finally, the second comprehensive feature is inputted into the text mapping layer of the third network, and text mapping is performed to acquire a fourth reply text of the fifth round.

First of all, the training of the model in this disclosure is performed in stages. For example, training of the first network is completed at first. For example, the first network is a pre-trained network having the audio recognition function. For example, the audio sample and a text label corresponding to the audio sample are acquired, and then model training is performed by using the audio sample and the text label to acquire the first network. Thus, a training process of the first network can be simple and will not be described in detail. This disclosure mainly describes a training process of the second network, and a model training process of this disclosure may also be understood as the training process of the second network accordingly. The model training process of this disclosure will be described in detail below in combination with the model shown in FIG. 2 and the model shown in FIG. 3.

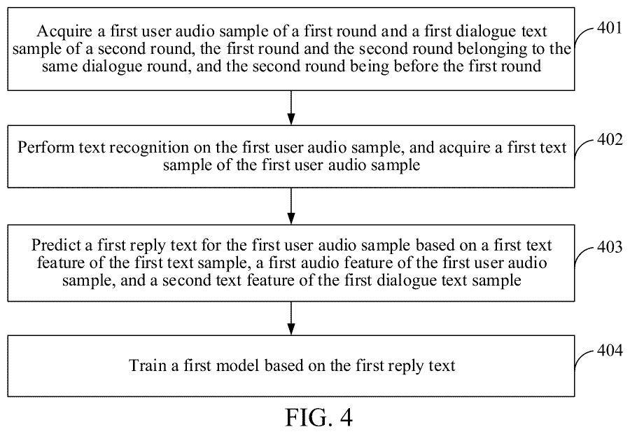

FIG. 4 is a schematic flowchart of a method for training a model according to an aspect of this disclosure. This method is applied to an apparatus for training a model. The method includes, but is not limited to, the following operations:
401: Acquire a first user audio sample of a first round and a first dialogue text sample of a second round, the first round and the second round belonging to the same dialogue round, and the second round being before the first round. For example, a first audio sample and a second text sample of a second audio sample are obtained. The second audio sample is before the first audio sample.

For example, the first round may be understood as a current round, the first user audio sample may be understood as an audio sample corresponding to the current round, the second round may be understood as a historical round in the same dialogue round before the first round, and the second round may be some or all of the historical rounds. For example, when a length of the historical rounds is overlong, the historical rounds may be cut and partial historical rounds may be kept, so as to guarantee that a length of a dialogue text sample of the historical round satisfies a requirement from the model. The first dialogue text sample needs to be inputted into a third network in the form of text, and the first dialogue text sample includes a user text, corresponding to the user audio, of a user in the second round and a reply text for the user audio.

For the convenience of description, this disclosure is mainly described with the second round including all the historical rounds as an example, and the first dialogue text sample includes the text corresponding to the user audio in each historical round and the reply text for the text.

In some aspects, the first dialogue text sample and the first user audio sample may be obtained from different dialogue sessions. For example, the first dialogue text sample may be obtained from a previous dialogue session that occurred before the dialogue session containing the first user audio sample.

In some aspects, the first dialogue text sample is generated by performing speech recognition on a second user audio sample captured before the first user audio sample. The second user audio sample may be from the same dialogue session as the first user audio sample or from a different dialogue session.
402: Perform text recognition on the first user audio sample, and acquire a first text sample of the first user audio sample. For example, a first text sample is generated based on speech recognition that is performed on the first audio sample.

For example, feature extraction is performed on the first user audio sample to acquire a second audio feature of the first user audio sample. For example, the first user audio sample may be inputted into an encoder of a first network, and the feature extraction is performed on the first user audio sample by using the encoder of the first network to acquire the second audio feature.

Then, text mapping is performed based on the second audio feature to acquire the first text sample. For example, the second audio feature may be inputted into a text mapping layer of the first network, and the text mapping is performed to acquire the first text sample.
403: Predict a first reply text for the first user audio sample based on a first text feature of the first text sample, a first audio feature of the first user audio sample, and a second text feature of the first dialogue text sample. For example, through a first dialogue model, a first predicted reply text for the first audio sample is generated based on a first text feature of the first text sample, a first audio feature of the first audio sample, and a second text feature of the second text sample.

For example, the feature extraction is performed on the first text sample to acquire the first text feature. For example, the first text sample is inputted into a tokenier layer of the third network, and tokenization is performed to acquire a plurality of tokens corresponding to the first text sample. Then, each token is inputted into an embedding layer of the third network and is embedded, and the first text feature corresponding to the first text sample is acquired.

For example, the feature extraction is performed on the first user audio sample to acquire the first audio feature of the first user audio sample. For example, the first user audio sample is inputted into an encoder of a second network. The feature extraction is performed on the first user audio sample by using the encoder to acquire the second audio feature corresponding to the first user audio sample. Then, the second audio feature is aligned, and the first audio feature is acquired. For example, the second audio feature is inputted into a dimension mapping layer of the third network and aligned to acquire the first audio feature.

After training of the first network is completed, the text mapping layer of the first network may be deleted to acquire the second network. In this way, when the second network is trained, an encoding parameter of the encoder of the first network and an encoding parameter of the encoder of the second network are identical at an initial stage of training, and the identical encoding parameter may be used for audio feature extraction. Thus, the second audio features extracted by the two networks are guaranteed similar without excessive deviations, the problem of unstable model training caused by the deviation of the audio feature is avoided, model jitter is prevented, and a convergence speed can be improved. With the training of the second network, the encoding parameter of the encoder in the second network is to be updated certainly, such that an updated encoding parameter of the encoder of the second network can be more suitable for an audio feature extraction task faced by a second network branch, and precision of the audio feature extraction is guaranteed.

For example, the feature extraction is performed on the first dialogue text sample to acquire the second text feature of the first dialogue text sample. For example, the first dialogue text sample is inputted into the tokenier layer of the third network, and tokenization is performed to acquire a plurality of tokens corresponding to the first dialogue text sample. Then, each token is inputted into the embedding layer of the third network and is embedded, and the second text feature of the first dialogue text sample is acquired.

For example, the first text feature, the first audio feature and the second text feature are spliced, and a first comprehensive feature is acquired.

In an implementation of this disclosure, a first prompt corresponding to the first text feature is acquired. The first prompt is configured for reminding that the first text feature is a feature of a text dimension, such that the model (namely, the text mapping layer of the third network) understands the user audio sample from the text dimension conveniently. For example, the first prompt prompt1 may be: “This is a text result of speech recognition, reply by taking the text result as a reference dimension”. A second prompt corresponding to the first audio feature is acquired. The second prompt is configured for reminding that the first audio feature is a feature of an audio dimension, such that the model (namely, the text mapping layer of the third network) understands the user audio sample from the audio dimension conveniently. For example, the second prompt prompt2 is: “This is a vector of speech mapping, reply by taking the vector as a reference dimension”.

Further, the feature extraction is performed on the first prompt to acquire a third text feature corresponding to the first prompt. For example, the feature extraction may be performed on the first prompt through the tokenier layer and the embedding layer of the third network to acquire the third text feature. The feature extraction is performed on the second prompt to acquire a fourth text feature corresponding to the second prompt. For example, the feature extraction may be performed on the second prompt through the tokenier layer and the embedding layer of the third network to acquire the fourth text feature.

Finally, the third text feature corresponding to the first prompt, the first text feature, the fourth text feature corresponding to the second prompt, the first audio feature, and the second text feature are spliced, and the first comprehensive feature is acquired. In this way, the model can better understand the first text feature based on the third text feature and better understand the first audio feature based on the fourth text feature when recognizing the first comprehensive feature.

For example, a spliced structure of the first comprehensive feature may be preset. For example, a splicing order of the spliced structure is preset as follows: [the text feature of the prompt 1, the feature indicated by the prompt 1, the text feature of the prompt 2, the feature indicated by the prompt 2, . . . , a text feature of a dialogue text of the historical round]. Then, according to the preset spliced structure, the first comprehensive feature may be acquired as follows:
[the third text feature the first text feature the fourth text feature the first audio feature the second text feature].

Further, a dimension of the feature of each part in the spliced structure may be pre-configured. Thus, after acquiring the first comprehensive feature, the model segments the first comprehensive feature to acquire the feature corresponding to each part based on the dimension of the feature of each part.

For example, the model may segment the first comprehensive feature into the third text feature, the first text feature, the fourth text feature, the first audio feature, and the second text feature, and may determine, based on the preset spliced structure, that the third text feature is configured for indicating the first text feature, the fourth text feature is configured for indicating the first audio feature, and the second text feature is the text feature of the dialogue text of the historical round. Then, the model understands the third text feature, may determine that the third text feature is configured for indicating the first text feature is the feature of a result (that is, the first text sample) of the text recognition corresponding to the user audio sample in the text dimension, and replies by taking the first text feature as a feature dimension. The model understands the fourth text feature, determines that the fourth text feature is configured for indicating the first text feature is the feature of the user audio sample in the audio dimension, and replies by taking the first audio feature as a feature dimension. In this way, the model can fully understand a meaning of the feature of each part of the first comprehensive feature, reply by using the first text feature of the user audio sample in the text dimension and the first audio feature of the user audio sample in the audio dimension, and reply by using information of the two dimensions. Thus, precision of the reply text is improved, precision of the dialogue is further improved, and experience of the user is improved.

In another implementation of this disclosure, preset elements may alternatively be directly spliced into the first comprehensive feature without constructing a special splicing structure. For example, a first element feature corresponding to a first preset element, a second element feature corresponding to a second preset element, a third element feature corresponding to a third preset element, and a fourth element feature corresponding to a fourth preset element are acquired. The first preset element, the second preset element, the third preset element and the fourth preset element may be identical or not, which is not limited in this disclosure. For example, a character or a token that rarely appear in the dialogue may be used as the preset element. For example, the character “segmentation” may be used as the first preset element, the second preset element, the third preset element, and the fourth preset element.

Then, the third text feature, the first element feature, the first text feature, the second element feature, the fourth text feature, the third element feature, the first audio feature, the fourth element feature, and the second text feature are sequentially spliced, and the first comprehensive feature is acquired. The first comprehensive feature is:
[the third text feature the first element feature the first text feature the second element feature the fourth text feature the third element feature the first audio feature the fourth element feature the second text feature].

Further, after splicing for the first comprehensive feature, the model may recognize the first element feature corresponding to the first preset element, the second element feature corresponding to the second preset element, the third element feature corresponding to the third preset element, and the fourth element feature corresponding to the fourth preset element from the first comprehensive features at first. Then, by using the first element feature, the second element feature, the third element feature, and the fourth element feature, the model segments the first comprehensive feature to acquire the third text feature, the first text feature, the fourth text feature, and the second text feature. Then, according to a segmentation order, the model determines that the first text feature is a feature indicated by the third text feature, the second text feature is the feature indicated by the fourth text feature, and the second text feature is the text feature of the dialogue text of the historical round. Finally, the model understands the third text feature, may determine that the third text feature is configured for indicating the first text feature is the feature of a result (that is, the first text sample) of the text recognition corresponding to the user audio sample in the text dimension, and replies by taking the first text feature as a feature dimension. The model understands the fourth text feature, determines that the fourth text feature is configured for indicating the first text feature is the feature of the user audio sample in the audio dimension, and replies by taking the first audio feature as a feature dimension. In this way, the model can fully understand a meaning of the feature of each part of the first comprehensive feature, reply by using the feature of the user audio sample in the text dimension and the feature of the user audio sample in the audio dimension, and reply by using information of the two dimensions. Thus, precision of the reply text is improved, precision of the dialogue is further improved, and experience of the user is improved. Moreover, in this implementation, the special spliced structure is unnecessary to design, the text feature corresponding to a special character merely need to be inserted between the original text feature and audio feature, and a corresponding feature can be acquired by segmenting the first comprehensive feature. Thus, complexity of splicing is reduced, efficiency of the splicing is improved, and efficiency of the dialogue is improved.

Finally, the first reply text is predicted based on the first comprehensive feature. For example, the first comprehensive feature is inputted into the text mapping layer of the third network, and the text mapping is performed to acquire the first comprehensive feature. The first reply text includes a plurality of tokens, and when the first reply text is generated, the third network generates the first reply text token by token. For example, the third network outputs a first token based on the first comprehensive feature at first, and then outputs a second token based on the first token and the first comprehensive feature until a preset token is outputted, for example, an end token, and the first reply text is acquired. In addition, when each token is generated, a probability of falling into each preset token is predicted, and the token with a highest probability is taken as the token.
404: Train a first model based on the first reply text. For example, the first dialogue model is trained based on the first predicted reply text.

The first model is an initial model constructed in advance. In some aspects, the first model includes the first network, the second network, and the third network. The first network and the third network are pre-trained, and this disclosure mainly describes the training process of the second network.

For example, for the first user audio sample, a label text corresponding to the first user audio sample is constructed, that is, a real reply content corresponding to the first user audio sample. Then, position encoding is performed based on the label text and the preset token, and a hard label corresponding to each token in the first reply text is constructed.

For example, the hard label is configured for indicating whether the sample belongs to a particular category, is expressed as 0 if the sample belongs to the particular category, and is expressed as 1 if the sample does not belong to the particular category. For example, a real category corresponding to the sample is a category 1, and a preset category includes the category 1, a category 2, and a category 3. Then the hard label corresponding to this sample is [1,0,0]. For the token, the hard label corresponding to the token indicates whether the token belongs to each preset token, the hard label may indicate the preset token, corresponding to each token, of the preset tokens, and a corresponding preset token may alternatively be understood as a real token corresponding to a sampling position where the token is located. The preset token is a pre-configured token in a dictionary. For example, the preset tokens include a preset token 1, a preset token 2, . . . , and a preset token n. If the preset token corresponding to a token 1 is the token 1, the hard label corresponding to the token 1 is [1, 0, . . . , 0].

Further, a soft label corresponding to each token is determined based on a number of the preset tokens and the hard label corresponding to each token. For example, the soft label is different from the hard label. The soft label indicates probabilities that the sample belongs to the categories. For example, if the probabilities that the sample belongs to the categories is 0.2, 0.3, and 0.5, the soft label corresponding to the sample is [0.2, 0.3, 0.5]. Thus, the soft label corresponding to the token is configured for indicating the probabilities that the token belongs to the preset tokens.

For example, a first preset token corresponding to each token, namely, the real token of the sampling position corresponding to the token is determined from the preset tokens based on the hard label corresponding to each token. Then, a weight corresponding to the first preset token and a weight corresponding to a second preset token are determined based on the number of the preset tokens and a preset parameter. The second preset token is a present token, other than the first preset token, of the preset tokens. The second preset tokens may be the remaining preset tokens except the first preset token. For example, the first preset token corresponding to the token is the preset token 1, the second preset tokens corresponding to the token are the preset token 2, . . . , and the preset token n. The preset parameter is less than a first threshold. For example, the preset parameter is a small number, such as 0.01 and 0.02. Finally, the soft label corresponding to each token is determined based on the weight corresponding to the first preset token and the weight corresponding to the second preset token. For example, the probability that a token belongs to the first preset token is determined based on the weight corresponding to the first preset token. The probability that a token belongs to the second preset token is determined based on the weight of the second preset token. Thus, the probabilities that each token belongs to the preset tokens are acquired. Finally, the soft label corresponding to each token is determined based on the probabilities that each token belongs to the preset tokens.

Further, a loss corresponding to each token is determined based on the soft label corresponding to each token and a probability corresponding to each preset token when each token is predicted. The first model is trained based on the loss corresponding to each token.

For example, the loss corresponding to each token may be expressed by a formula as follows:

$${ℒ}_{ce \_ soft} = - {\sum }_{i = lable} ( 1 - ϵ + \frac{ϵ}{N} ) * log {p}_{{LLM}_{i}} ( {y}_{{label}_{i}} \vert {y}_{concat} < N , {h}_{enc} , {Θ}_{LLM} ) + {\sum }_{i \neq lable}^{N} ( \frac{ε}{N} ) log {p}_{{LLM}_{i}} ( {y}_{{label}_{i}} \vert {y}_{concat} < N , {h}_{enc} , {Θ}_{L L M} ) ;$$

In the formula, i denotes an i^{th} token in the first reply text, [symbol] _{ce} soft denotes the loss corresponding to the i^{th} token, E denotes the preset parameter, N denotes the number of the preset tokens, i=lable denotes a case where that the i^{th} token belongs to the first preset token corresponding to the i^{th} token, y_{concat} denotes the first comprehensive feature, h_{enc} denotes the first audio feature, Θ_{LLM} denotes the network parameter of the third network, y_{label}_{ᵢ} denotes the hard label corresponding to the i^{th} token, and p_{LLM}_{ᵢ} denotes a probability of falling into the first preset token corresponding to the i^{th} token. Thus, log p_{LLM}_{ᵢ} (y_{label}_{ᵢ}|y_{concat}<N, h_{enc}; Θ_{LLM}) denotes the probability of falling into the first preset token corresponding to the i^{th} token when the network parameter Θ_{LLM} is used for prediction among the N preset tokens in a case where the first audio feature h_{enc} is spliced in the first comprehensive feature y_{concat}. In the formula, i≠lable denotes a case where the i^{th} token does not belong to the first preset token corresponding to the i^{th} token, and log p_{LLM}_{ᵢ} (y_{label}_{ᵢ}|y_{concat}<N, h_{enc}; Θ_{LLM}) denotes the probability of falling into the second preset token corresponding to the i^{th} token, for example, the probability of falling into the preset tokens except the first token.

Thus, the

$$( 1 - ϵ + \frac{ϵ}{N} )$$

may be regarded as the weight corresponding to the first preset token and

$$( \frac{ϵ}{N} )$$

may be regarded as the weight corresponding to the second preset token. Then, the hard label [0, 0, 0, . . . , 1, 0, 0] of the token may be adjusted to the soft label

$$[ \frac{ϵ}{N} , \frac{ϵ}{N} , \frac{ϵ}{N} , …… , 1 - ϵ + \frac{ϵ}{N} , \frac{ϵ}{N} , \frac{ϵ}{N} ] .$$

The probability that the token in the soft label belongs to the real token corresponding to the token is

$$1 - ϵ + \frac{ϵ}{N}$$

and is less than 1. In this way, the weight of the real token corresponding to the token is reduced, and the labeled hard label is not trusted excessively, thus solving the problem of unstable training caused by a labeling error, and improving the precision of model training.

Thus, the formula may also be simplified as:

$${ℒ}_{ce \_ soft} = - {\sum }_{i = lable} ( 1 - ϵ + \frac{ϵ}{N} ) * log {p}_{{LLM}_{i}} * {y}_{{label}_{i}} + {\sum }_{i \neq lable}^{N} ( \frac{ϵ}{N} ) log {p}_{{LLM}_{i}} * {y}_{{label}_{i}} ;$$

In the formula, y_{label}_{ᵢ} in a former item denotes a probability of the first preset token corresponding to the i^{th} token in the hard label corresponding to the i^{th} token, and y_{label}_{ᵢ} in a latter item denotes a probability of the second preset token corresponding to the i^{th} token in the hard label corresponding to the i^{th} token.

Further, the first model is trained based on the loss corresponding to each token. For example, the losses corresponding to the tokens are summed to acquire a target loss, and a network parameter of the second network is adjusted based on the target loss. Thus, the second network is trained, for example, the first model is trained.

Further, the first model is trained based on the loss corresponding to each token, and a second model is acquired. Then, a second user audio sample of a third round and a second dialogue text sample of a fourth round are acquired. The third round and the fourth round belong to the same dialogue round, and the fourth round are before the third round. Similarly, the second user audio sample and the second dialogue text sample are inputted into the second model, and a plurality of second reply texts are acquired for the second user audio sample. A method for acquiring each second reply text is similar to the method for acquiring the first reply text described above, and will not be described again. However, when the second reply text is acquired, a temperature of the third network is controlled to be less than a threshold, and then the model generates the plurality of second reply texts for the second user audio sample. By generating the plurality of second reply texts, diversity of reply contents can be increased, more choices can be made, and richness of training samples can be increased.

Then, a third reply text corresponding to the second user audio sample is determined from the plurality of second reply texts. The third reply text is the second reply text, having a highest degree of correlation with the second user audio sample, of the plurality of second reply texts.

In some aspects, the plurality of second reply texts are displayed, and the second reply text selected by the user is taken as the third reply text corresponding to the second user audio sample.

In some aspects, partial second reply texts selected by the user from the plurality of second reply texts are acquired, for example, the partial texts selected by the user from the plurality of second reply texts that match the intention of the second user audio sample from the plurality of second reply texts. Then, a third prompt corresponding to the second user audio sample is constructed based on a second text sample of the second user audio sample, the second dialogue text sample, and the partial second reply texts. For example, the partial second reply texts are taken as an example, and the large model digs out a matching rule between the second text sample and the second reply text based on the second text sample of the audio sample and the partial second reply texts. For example, the third prompt may be provided as below.

Supposing you are an expert in the field of intelligent customer service dialogues, now the user text corresponding to the user audio is the “second text sample”. The following text reply examples are relatively correct reply contents:
Text reply example 1: “second reply text 1”;
Text reply example 2: “second reply text 2”;
. . . ;

Then, based on the matching rules between the “second text sample” and several text reply examples, the plurality of candidate reply texts below are scored. The higher the score is, the higher a degree of matching of the reply text to the second text sample is.
Candidate reply text 1: “second reply text 1”;
Candidate reply text 2: “second reply text 2”;
. . .
Candidate reply text m: “second reply text m”.

Then, each second reply text of the plurality of second reply texts is scored based on the third prompt, and a score of each second reply text is acquired. The score of each second reply text is configured for indicating a degree of correlation between each second reply text and the second user audio sample. The higher the score is, the higher the degree of correlation is.

Finally, the third reply text is determined based on the score of each second reply text. The third reply text is the second reply text, having a highest score, of the plurality of second reply texts.

Further, based on the second user audio sample, the second dialogue text sample, and the third reply text, the second model is trained. For example, the second model is trained by using the third reply text as a label text of the second user audio sample. A training process of the second model is similar to the training process of the first model, and will not be repeated. In the implementation of this disclosure, through repeated model iterations and human feedback, the model can be closer to human preference and business preference, the model can make a text reply most desired by the user, and dialogue experience can be improved.

The third model may be acquired by training the second model, and then a process similar to the process of the second model is performed on the third model. Iterative training is continuously performed until the trained model converges. Thus, the training of the model is completed, the trained second network is acquired, the trained model can be acquired, and the trained model can be used for the intelligent customer service dialogue.

In the aspect of this disclosure, when the model for the dialogue is trained, the audio sample is converted into a corresponding text sample at first, then the text feature of the text sample in a dimension is acquired, and the text feature of the audio sample in a text dimension is further acquired. In addition, audio feature extraction is performed on the audio sample, and the audio feature of the audio sample in an audio dimension is acquired. Then, the model is trained comprehensively by using the text feature of the audio sample in the text dimension, the audio feature of the audio sample in the audio dimension, and a text feature of a historical dialogue. In this way, during training, the audio feature and the text feature can learn from each other, and a training effect of the model can be improved accordingly. Precision of the reply text outputted by the model is not affected even if precision of the feature in a particular dimension is insufficient. Thus, robustness of the model is improved, the user can be provided with a high-precision reply text, and the experience of the user in the intelligent customer service dialogue can be improved.

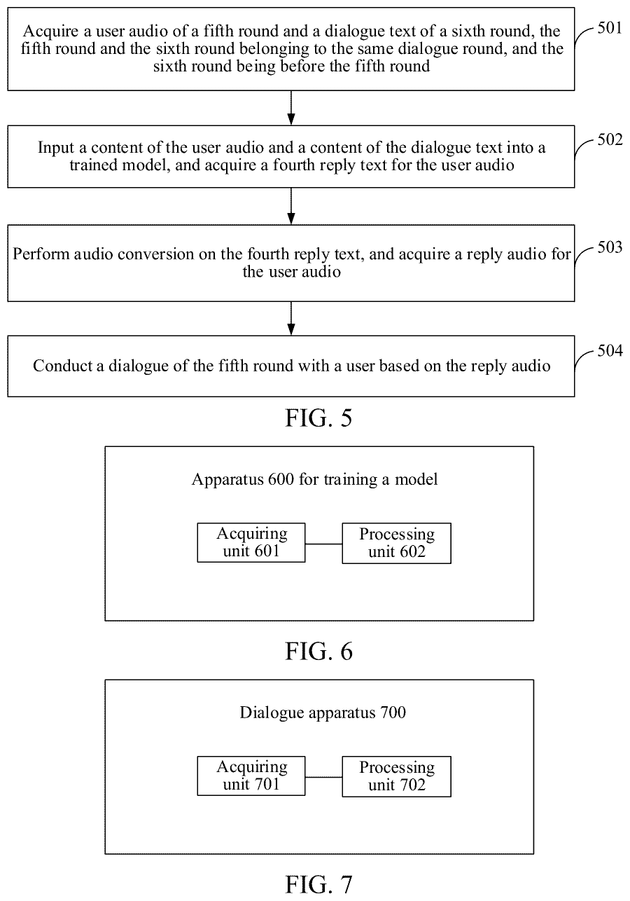

With reference to FIG. 5, FIG. 5 is a schematic flowchart of a dialogue method according to an aspect of this disclosure. This method is applied to a dialogue apparatus. The method includes, but is not limited to, the following operations:
501: Acquire a user audio of a fifth round and a dialogue text of a sixth round, the fifth round and the sixth round belonging to the same dialogue round, and the sixth round being before the fifth round. For example, for a dialogue session, an audio input and a dialogue text input are obtained. The dialogue text input is obtained before the audio input.

The fifth round may alternatively be referred to as a current round, the sixth round is a historical round before the current round, and the sixth round may include all historical rounds before the current round or partial historical rounds. The dialogue text of the sixth round includes a question text outputted by a user and a reply text for the question text.

The dialogue round to which the fifth round and the sixth round belong may be one dialogue round in an intelligent customer service scenario.
502: Input a content of the user audio and a content of the dialogue text into the trained model, and acquire a fourth reply text for the user audio. For example, through a trained dialogue model, a predicted reply text for the audio input is generated based on the audio input and the dialogue text input.

A method for acquiring the fourth reply text is similar to the method for acquiring the first reply text for the first user audio sample described above, and will not be described in detail.

For example, the user audio of the fifth round may be inputted into an encoder of a first network, and feature extraction is performed on the user audio to acquire a third audio feature. Then, the third audio feature is inputted into a text mapping layer of the first network, and text mapping is performed to acquire a user text corresponding to the user audio. The user audio is inputted into an encoder of a second network, and the feature extraction is performed on the user audio to acquire a fourth audio feature. Then, the fourth audio feature is inputted into a dimension mapping layer to map a fifth audio feature whose dimension satisfies a requirement from a third network. Then, the dialogue text of the sixth round is inputted into a tokenier layer of the third network, tokenization is performed to acquire a plurality of tokens of the dialogue text. The user text is inputted into the tokenier layer of the third network, and tokenization is performed to acquire a plurality of tokens of the user text. Then, the plurality of tokens of the user text are inputted into an embedding layer of the third network, and are embedded, and a text feature of the user text is acquired. The plurality of tokens of the dialogue text are inputted into the embedding layer of the third network, and are embedded, and a text feature of the dialogue text is acquired.

Further, the text feature of the user text, the text feature of the dialogue text, and the fifth audio feature are spliced to acquire a second comprehensive feature. Finally, the second comprehensive feature is inputted into a text mapping layer of the third network, and text mapping is performed to acquire a reply text of the fifth round.
503: Perform audio conversion on the fourth reply text, and acquire a reply audio for the user audio. For example, the predicted reply text is converted into a reply audio.

For example, the fourth reply text may be converted into the reply audio through text to speech (TTS) conversion technology.
504: Conduct a dialogue of the fifth round with a user based on the reply audio. For example, a reply to the audio input is output based on the reply audio.

In the aspect of this disclosure, the trained model is used for generating a corresponding reply text for the user. Since the trained model has strong robustness, the generated reply text has high precision, a dialogue effect can be improved, and experience of the user in the intelligent customer service dialogue can be improved.

With reference to FIG. 6, FIG. 6 is a schematic diagram of an apparatus for training a model according to an aspect of this disclosure. The apparatus 600 for training a model includes an acquiring unit 601 and a processing unit 602.

The acquiring unit 601 is configured to acquire a first user audio sample of a first round and a first dialogue text sample of a second round, the first round and the second round belonging to the same dialogue round, and the second round being before the first round.

The processing unit 602 is configured to perform text recognition on the first user audio sample, and acquire a first text sample of the first user audio sample; predict a first reply text for the first user audio sample based on a first text feature of the first text sample, a first audio feature of the first user audio sample, and a second text feature of the first dialogue text sample; and train a first model based on the first reply text.

In an implementation of this disclosure, the first reply text includes a plurality of tokens. In the aspect of training a first model based on the first reply text, the processing unit 602 is configured to:
determine a soft label corresponding to each token based on a number of preset tokens and a hard label corresponding to each token;
determine a loss corresponding to each token based on the soft label corresponding to each token and a probability corresponding to each preset token when each token is predicted; and
train the first model based on the loss corresponding to each token.

In an implementation of this disclosure, in the aspect of determining a soft label corresponding to each token based on a number of preset tokens and a hard label corresponding to each token, the processing unit 602 is configured to:
determine a first preset token corresponding to each token from the preset tokens based on the hard label corresponding to each token;
determine a weight corresponding to the first preset token and a weight corresponding to a second preset token based on the number of the preset tokens and a preset parameter; and
determine the soft label corresponding to each token based on the weight corresponding to the first preset token and the weight corresponding to the second preset token.

In an implementation of this disclosure, in the aspect of training the first model based on the loss corresponding to each token, the processing unit 602 is configured to:
train the first model based on the loss corresponding to each token, and acquire a second model;
acquire a second user audio sample of a third round and a second dialogue text sample of a fourth round, the third round and the fourth round belonging to the same dialogue round, and the fourth round being before the third round;
input the second user audio sample and the second dialogue text sample into the second model, and acquire a plurality of second reply texts for the second user audio sample;
determine a third reply text corresponding to the second user audio sample from the plurality of second reply texts, the third reply text being the second reply text, having a highest degree of correlation with the second user audio sample, of the plurality of second reply texts; and
train the second model based on the second user audio sample, the second dialogue text sample, and the third reply text.

In an implementation of this disclosure, in the aspect of determining a third reply text corresponding to the second user audio sample from the plurality of second reply texts, the processing unit 602 is configured to:
select partial second reply texts from the plurality of second reply texts;
construct a third prompt corresponding to the second user audio sample based on a second text sample of the second user audio sample, the second dialogue text sample, and the partial second reply texts;
score each second reply text of the plurality of second reply texts based on the third prompt, and acquire a score of each second reply text, the score of each second reply text being configured for indicating a degree of correlation between each second reply text and the second user audio sample; and
determine the third reply text based on the score of each second reply text, the third reply text being the second reply text, having a highest score, of the plurality of second reply texts.

In an implementation of this disclosure, in the aspect of predicting a first reply text for the first user audio sample based on a first text feature of the first text sample, a first audio feature of the first user audio sample, and a second text feature of the first dialogue text sample, the processing unit 602 is configured to:
splice the first text feature, the first audio feature, and the second text feature, and acquire a first comprehensive feature; and
predict the first reply text based on the first comprehensive feature.

In an implementation of this disclosure, in the aspect of splicing the first text feature, the first audio feature, and the second text feature, and acquiring a first comprehensive feature, the processing unit 602 is configured to:
acquire a first prompt corresponding to the first text feature;
acquire a second prompt corresponding to the first audio feature; and
splice a third text feature corresponding to the first prompt, the first text feature, a fourth text feature corresponding to the second prompt, the first audio feature, and the second text feature, and acquire the first comprehensive feature.

In an implementation of this disclosure, in the aspects of splicing a third text feature corresponding to the first prompt, the first text feature, a fourth text feature corresponding to the second prompt, the first audio feature, and the second text feature, and acquiring the first comprehensive feature, the processing unit 602 is configured to:
acquire a first element feature corresponding to a first preset element, a second element feature corresponding to a second preset element, a third element feature corresponding to a third preset element, and a fourth element feature corresponding to a fourth preset element; and

sequentially splice the third text feature, the first element feature, the first text feature, the second element feature, the fourth text feature, the third element feature, the first audio feature, the fourth element feature, and the second text feature, and acquire the first comprehensive feature.

In an implementation of this disclosure, the first model includes a first network and a second network, the first network and the second network have encoders that have the same encoding parameter, and in the aspects of performing text recognition on the first user audio sample, and acquiring a first text sample of the first user audio sample, the processing unit 602 is configured to:
input the first user audio sample into the first network, perform feature extraction on the first user audio sample based on the encoding parameter of the encoder of the first network, and acquire a second audio feature of the first user audio sample; and
map the second audio feature through a text mapping layer of the first network, and acquire the first text sample.

The processing unit 602 is further configured to:
input the first user audio sample into the second network, perform feature extraction on the first user audio sample according to the encoding parameter of the encoder of the second network, and acquire the second audio feature of the first user audio sample; and
align the second audio feature, and acquire the first audio feature.

In an implementation of this disclosure, the processing unit 602 is further configured to:
pre-train the first network, delete a text mapping layer of the first network, and acquire the second network.

With reference to FIG. 7, FIG. 7 is a schematic diagram of a dialogue apparatus according to an aspect of this disclosure. The dialogue apparatus 700 includes: an acquiring unit 701 and a processing unit 702.

The acquiring unit 701 is configured to acquire a user audio of a fifth round and a dialogue text of a sixth round, the fifth round and the sixth round belonging to the same dialogue round, and the sixth round being before the fifth round.

The processing unit 702 is configured to input a content of the user audio and a content of the dialogue text into the model trained by the method for training a model described above, and acquire a fourth reply text for the user audio;
perform audio conversion on the fourth reply text, and acquire a reply audio for the user audio; and
conduct a dialogue of the fifth round with a user based on the reply audio.

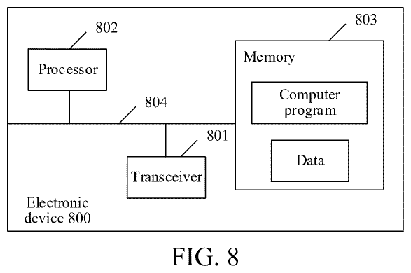

With reference to FIG. 8, FIG. 8 is a schematic diagram of an electronic device according to an aspect of this disclosure. As shown in FIG. 8, the electronic device 800 includes a transceiver 801, a processor 802 (e.g., processing circuitry), and a memory 803 (e.g., a non-transitory computer-readable storage medium). The transceiver, the processor, and the memory are connected through a bus 804. The memory 803 is configured to store a computer program and data, and may transmit the data stored in the memory 803 to the processor 802. The electronic device 800 may be a laser processing device described above. The processor 802 is configured to read the computer program from the memory 803, so as to perform operations of the method for training a model or the dialogue method of the aspect of this disclosure. In some aspects, the electronic device may be the apparatus 600 for training a model or the dialogue apparatus 700 described above.

The processor 802 may adopt a general central processing unit (CPU), a microprocessor, an application specific integrated circuit (ASIC), a graphics processing unit (GPU), or one or more integrated circuits, and is configured to execute a related program, so as to perform the aspect of the method for training a model or the aspect of the dialogue method of this disclosure.

The processor 802 may also be an integrated circuit chip having a signal processing capacity. In an implementation process, the operations of the method for training a model or the dialogue method of this disclosure may be completed by an integrated logic circuit of hardware or an instruction in the form of software in the processor 802. The processor 802 may also be a general-purpose processor, a digital signal processor (DSP), an application specific integrated circuit (ASIC), a field-programmable gate array (FPGA), a different programmable logic device, discrete gate or transistor logic device, or a discrete hardware component. The methods, steps and logic blocks disclosed in the aspects of this disclosure may be implemented or performed. The general-purpose processor may be a microprocessor, or the processor may also be any other processor, etc. The steps of the method disclosed in conjunction with the aspects of this disclosure may be directly embodied to be performed and completed by a hardware decoding processor, or may be performed and completed through a combination of hardware and software modules in the decoding processor. The software module may be located in a mature storage medium in the art, such as a random access memory, a flash memory, a read-only memory, a programmable read-only memory, an electrically erasable programmable memory, and a register. The storage medium is located in the memory 803, and the processor 802 reads information from the memory 803, and performs the operations in the aspect of the method for training a model or the aspect of the dialogue method of this disclosure in combination with the hardware.

The transceiver 801 is configured to implement communication between the electronic device 800 and another device or communication network. For example, a bitmap of a workpiece may be acquired through the transceiver 801.

The bus 804 may include paths for transmitting information between components (such as the transceiver 801, the processor 802, and the memory 803) of the electronic device 800.

Although the electronic device 800 shown in FIG. 8 merely shows the transceiver, the memory, and the processor, in an example implementation process, it is noted that the electronic device 800 further includes another device necessary for normal running. Meanwhile, it is also noted that the electronic device 800 may also include a hardware device that implements another additional function. In addition, it is noted that the electronic device 800 may alternatively include merely the device required to implement the aspect of this disclosure, rather than include all the devices shown in FIG. 8 unnecessarily.

It is noted that reference can be made to the corresponding processes in the foregoing method aspects for the specific work processes of the device, apparatus and unit, which will not be repeated herein.

The user device in this disclosure may include a mobile phone, a tablet computer, a palmtop computer, a notebook computer, a mobile internet device, a wearable device, etc. The electronic devices are merely examples rather than exhaustive, and include, but are not limited to, the electronic devices described above. In an actual application, the electronic device may also include an intelligent vehicle terminal, a computer device, etc.

A server for the apparatus for training a model or the dialogue apparatus of this disclosure may be a cloud computing server, a content delivery network (CDN) server, a network time protocol (NTP) server, a domain name system (DNS) server, and a server of another type. The servers are merely examples rather than exhaustive, and include, but are not limited to, the servers described above.

The aspects of this disclosure further provide a computer-readable storage medium, such as a non-transitory computer-readable storage medium. The computer-readable storage medium has a computer program stored therein, the computer program, when executed by a processor, implementing some or all operations of any method for training a model or any dialogue method in the method aspects described above.

The aspects of this disclosure further provide a computer program product. The computer program product includes a non-transitory computer-readable storage medium having a computer program stored therein, the computer program may operate to cause a computer to perform some or all operations of any method for training a model or any dialogue method in the method aspects described above.

For simple description, all the foregoing method aspects are expressed as a series of action combinations, it is noted that this disclosure is not limited by the action order described since some steps can be performed in another order or at the same time according to this disclosure. In addition, it is also noted that the aspects described in the description are all examples of aspects, and the actions and modules involved are not necessarily necessary for this disclosure.

In the aspects, descriptions of the aspects have emphases. For a portion not detailed in a particular aspect, reference can be made to relevant descriptions of another aspect.

In several aspects according to this disclosure, the apparatus disclosed may be implemented in another mode. For example, the apparatus aspects described above are merely examples. For example, unit division is merely a logical function division and can have other division modes during actual implementation. For example, a plurality of units or components can be combined or integrated into another system, or some features can be omitted or not performed. On the other hand, the coupling, direct coupling, or communication connection with each other shown or discussed can be indirect coupling or communication connection through some interfaces, apparatuses or units, and can be in an electrical form or another form.

The units described as separated parts can be physically separated or not, and the parts displayed as units can be physical units or not, that is, they can be located in one place or distributed to a plurality of network units. Some or all units can be selected according to actual demand to achieve the purposes of the solutions of the aspects.

In addition, functional units in the aspects of this disclosure may be integrated into one processing unit, or each unit may be physically present separately, or two or more units may be integrated into one unit. The integrated units may be implemented in the form of hardware, or may be implemented in the form of software program module.

If the integrated units are implemented in the form of software program module and sold or used as independent products, they may be stored in a computer-readable storage medium. Based on such understanding, the technical solution of this disclosure may be embodied in the form of software products in essence or in part that contributes to the related art or in part or whole, the computer software products are stored in the memory, and include several instructions to make one computer device (may be a personal computer, a server, a network device, etc.) perform all or some steps of the method of the aspects of this disclosure. The foregoing memory includes: a USB flash drive, a read-only memory (ROM), a random access memory (RAM), a mobile hard disk drive, a diskette, an optical disk, etc., that may store program codes.

It is noted that all or some steps of the methods of the aspects can be completed by instructing related hardware through a program, and the program may be stored in a computer-readable memory. The memory may include a flash disk, a read-only memory (ROM), a random access memory (RAM), a magnetic disk, an optical disk, etc.

The aspects of this disclosure have been described in detail. Examples are used herein to explain the principles and the implementation of this disclosure. The foregoing description of the aspects is merely intended to help understand the method of this disclosure and its core ideas. Modifications can be made to example implementations and the disclosure scope according to the ideas of this disclosure. To sum up, the contents of the description are to be not understood as limiting the scope of this disclosure.

What is claimed is:

1. A method for training a dialogue model, comprising:
obtaining a first audio sample and a second text sample of a second audio sample, the second audio sample being before the first audio sample;
generating a first text sample based on speech recognition that is performed on the first audio sample;
generating, through a first dialogue model, a first predicted reply text for the first audio sample based on a first text feature of the first text sample, a first audio feature of the first audio sample, and a second text feature of the second text sample; and
training the first dialogue model based on the first predicted reply text.

2. The method according to claim 1, wherein the first predicted reply text includes a plurality of tokens, and the training the first dialogue model comprises:
determining a soft label corresponding to each token of the plurality of tokens based on a plurality of preset tokens and a hard label corresponding to the respective token;
determining a loss value corresponding to each token of the plurality of tokens based on the soft label corresponding to the respective token and a predicted probability distribution of the plurality of preset tokens; and
training the first dialogue model based on the loss value corresponding to each token.

3. The method according to claim 2, wherein the determining the soft label corresponding to each token comprises:
determining a first preset token from the plurality of preset tokens based on the hard label corresponding to the respective token;
determining a first weight corresponding to the first preset token and a second weight corresponding to a second preset token, the first weight and the second weight being determined based on a total number of the plurality of preset tokens and a preset parameter; and
determining the soft label corresponding to the respective token based on the first weight and the second weight.

4. The method according to claim 2, wherein the training the first dialogue model based on the loss value corresponding to each token comprises:
training the first dialogue model based on the loss value corresponding to each token to obtain a second dialogue model;
obtaining a third audio sample and a fourth text sample of a fourth audio sample, the fourth audio sample being before the third audio sample;
obtaining, through the second dialogue model, a plurality of second predicted reply texts for the third audio sample based on the third audio sample and the fourth text sample;
determining a third predicted reply text corresponding to the third audio sample from the plurality of second predicted reply texts, the third predicted reply text being a second predicted reply text having a highest degree of correlation with the third audio sample among the plurality of second predicted reply texts; and
training the second dialogue model based on the third audio sample, the fourth text sample, and the third predicted reply text.

5. The method according to claim 4, wherein the determining the third predicted reply text comprises:
selecting a subset of the plurality of second predicted reply texts as candidate predicted reply texts;
generating a third text sample based on speech recognition that is performed on the third audio sample;
constructing a third prompt corresponding to the third audio sample based on the third text sample, the fourth text sample, and the candidate predicted reply texts;
scoring each second predicted reply text of the plurality of second predicted reply texts based on the third prompt to obtain a correlation score of the respective second predicted reply text, the correlation score indicating a degree of correlation between the respective second predicted reply text and the third audio sample; and
determining the third predicted reply text based on the correlation score of each second predicted reply text, the third predicted reply text being the second predicted reply text of the plurality of second predicted reply texts having a highest correlation score.

6. The method according to claim 1, wherein the generating the first predicted reply text comprises:
splicing the first text feature, the first audio feature, and the second text feature to obtain a first comprehensive feature; and
predicting the first predicted reply text based on the first comprehensive feature.

7. The method according to claim 6, wherein the splicing comprises:
obtaining a first prompt corresponding to the first text feature;
obtaining a second prompt corresponding to the first audio feature; and
splicing a third text feature that is extracted from the first prompt, the first text feature, a fourth text feature that is extracted from the second prompt, the first audio feature, and the second text feature to obtain the first comprehensive feature.

8. The method according to claim 7, wherein the splicing comprises:
obtaining (i) a first element feature corresponding to a first preset element, (ii) a second element feature corresponding to a second preset element, (iii) a third element feature corresponding to a third preset element, and (iv) a fourth element feature corresponding to a fourth preset element; and
sequentially splicing the third text feature, the first element feature, the first text feature, the second element feature, the fourth text feature, the third element feature, the first audio feature, the fourth element feature, and the second text feature to obtain the first comprehensive feature.

9. The method according to claim 1, wherein the first dialogue model includes a first network having a first encoder with an encoding parameter, and the speech recognition comprises:
inputting the first audio sample into the first network;
performing feature extraction on the first audio sample based on the encoding parameter of the first encoder of the first network to obtain a second audio feature of the first audio sample; and
mapping the second audio feature through a text mapping layer of the first network to obtain the first text sample.

10. The method according to claim 9, wherein the first dialogue model includes a second network having a second encoder with the encoding parameter of the first encoder of the first network; and the method further comprises:
inputting the first audio sample into the second network;
performing feature extraction on the first audio sample based on the encoding parameter of the second encoder of the second network to obtain the second audio feature of the first audio sample; and
obtaining the first audio feature based on the second audio feature.

11. A dialogue method, comprising:
obtaining an audio input and a dialogue text input, the dialogue text input being obtained before the audio input;
generating, through a trained dialogue model, a predicted reply text for the audio input based on the audio input and the dialogue text input;
converting the predicted reply text into a reply audio; and
outputting a reply to the audio input based on the reply audio, wherein
the trained dialogue model is trained with sample predicted reply text for a first audio sample,
the sample predicted reply text is generated through a first dialogue model based on a first sample text feature of a first text sample, a first audio feature of the first audio sample, and a second sample text feature of a second text sample,
the first text sample is generated based on speech recognition that is performed on the first audio sample,
the second text sample is obtained from a second audio sample, and
the second audio sample is obtained before the first audio sample.

12. The method according to claim 11, wherein the generating the predicted reply text comprises:
splicing a text feature that is extracted from the audio input, an audio feature that is extracted from the audio input, and a dialogue feature that is extracted from the dialogue text input to obtain a comprehensive feature; and
generating the predicted reply text based on the comprehensive feature.

13. The method according to claim 12, wherein the splicing comprises:
obtaining a first prompt corresponding to the text feature;
obtaining a second prompt corresponding to the audio feature; and
splicing a third feature that is extracted from the first prompt, the text feature, a fourth feature that is extracted from the second prompt, the audio feature, and the dialogue feature to obtain the comprehensive feature.

14. The method according to claim 13, wherein the splicing comprises:
obtaining (i) a first element feature corresponding to a first preset element, (ii) a second element feature corresponding to a second preset element, (iii) a third element feature corresponding to a third preset element, and (iv) a fourth element feature corresponding to a fourth preset element; and
sequentially splicing the third feature, the first element feature, the text feature, the second element feature, the fourth feature, the third element feature, the audio feature, the fourth element feature, and the dialogue feature to obtain the comprehensive feature.

15. The method according to claim 11, wherein the trained dialogue model includes a first network having an encoder with an encoding parameter, and the method further comprises:
inputting the audio input into the first network;
performing feature extraction on the audio input based on the encoding parameter of the encoder of the first network to obtain an intermediate audio feature;
mapping the intermediate audio feature through a text mapping layer of the first network to obtain a text sample; and
generating, through the trained dialogue model, the predicted reply text for the audio input based on the text sample and the dialogue text input.

16. A dialogue apparatus, comprising:
processing circuitry configured to:
obtain an audio input, and a dialogue text input that is obtained before the audio input;
generate, through a trained dialogue model, a predicted reply text for the audio input based on the audio input and the dialogue text input;
convert the predicted reply text into a reply audio; and
output a reply to the audio input based on the reply audio, wherein
the trained dialogue model is trained with sample predicted reply text for a first audio sample,
the sample predicted reply text is generated through a first dialogue model based on a first sample text feature of a first text sample, a first audio feature of the first audio sample, and a second sample text feature of a second text sample,
the first text sample is generated based on speech recognition that is performed on the first audio sample,
the second text sample is obtained from a second audio sample, and
the second text sample is obtained before the first audio sample.

17. The apparatus according to claim 16, wherein the processing circuitry is configured to:
splice a text feature that is extracted based on the audio input, an audio feature that is extracted based on the audio input, and a dialogue feature that is extracted based on the dialogue text input to obtain a comprehensive feature; and
generate the predicted reply text based on the comprehensive feature.

18. The apparatus according to claim 17, wherein the processing circuitry is configured to:
obtain a first prompt corresponding to the text feature;
obtain a second prompt corresponding to the audio feature; and
splice a third feature that is extracted from the first prompt, the text feature, a fourth feature that is extracted from the second prompt, the audio feature, and the dialogue feature to obtain the comprehensive feature.

19. The apparatus according to claim 18, wherein the processing circuitry is configured to:
obtain (i) a first element feature corresponding to a first preset element, (ii) a second element feature corresponding to a second preset element, (iii) a third element feature corresponding to a third preset element, and (iv) a fourth element feature corresponding to a fourth preset element; and
sequentially splice the third feature, the first element feature, the text feature, the second element feature, the fourth feature, the third element feature, the audio feature, the fourth element feature, and the dialogue feature to obtain the comprehensive feature.

20. The apparatus according to claim 16, wherein the trained dialogue model includes a first network having an encoder with an encoding parameter, and the processing circuitry is configured to:
input the audio input into the first network;
perform feature extraction on the audio input based on the encoding parameter of the encoder of the first network to obtain an intermediate audio feature;
map the intermediate audio feature through a text mapping layer of the first network to obtain a text sample; and
generate, through the trained dialogue model, the predicted reply text for the audio input based on the text sample and the dialogue text input.
